(19) United States
(12) Patent Application Publication
(10) Pub. No.: US 2014/0253043 A1
(43) Pub. Date: Sep. 11, 2014

(54) APPARATUS AND METHOD FOR WARNING CHARGE AMOUNT OF BATTERY

(71) Applicant: LG CHEM, LTD., Seoul (KR)

(72) Inventors: Sang-Eun Cho, Daejeon (KR); Jong-Hyun Chae, Daejeon (KR); Hyun-Chul Ha, Daejeon (KR)

(73) Assignee: LG CHEM, LTD., Seoul (KR)

(21) Appl. No.: 14/197,758

(22) Filed: Mar. 5, 2014

(30) Foreign Application Priority Data
Mar. 5, 2013 (KR) 10-2013-0023349

(51) Int. Cl. G08B 21/18; H02J 7/00

(52) U.S. Cl. CPC G08B 21/182; H02J 7/0021
USPC 320/134; 340/636.1

(57) ABSTRACT

Disclosed is an apparatus and method for warning a charge amount. The apparatus for warning a charge amount includes a storage unit to store an indication unit used to indicate a remaining charge amount of a battery and a warning value based on the indication unit, a measurement unit to measure an electrical characteristic value of the battery, a charge amount calculation unit to calculate a remaining charge amount from the measured electrical characteristic value of the battery, an indication unit conversion unit to convert the calculated remaining charge amount to an indication unit based on a power amount consumed in a load electrically connected to the battery by the indication unit, and a determination unit to output a warning signal when the converted remaining charge amount is less than or equal to the warning value. According to the present disclosure, a warning is provided to charge a battery before the battery is fully discharged. In this instance, the warning may be set to be provided by a unit of a desired form at a desired point in time by a user, so when the user uses a device including the battery, predictability in operation or management may be further improved.

### FIELD OF THE DISCLOSURE

The present disclosure relates to an apparatus and method for warning a charge amount of a battery, and more particularly, to an apparatus and method for calculating and displaying a remaining charge amount of a battery by a separate unit of indication.

### DESCRIPTION OF THE RELATED ART

Recently, as the demand for portable electronic products such as laptop computers, video cameras, and mobile phones is dramatically increasing and earnest efforts are being made to develop electric vehicles, hybrid electric vehicles, storage batteries for energy storage, robots, satellites, and the like, many studies are being conducted on high performance secondary batteries capable of repeatedly charging and discharging.

Currently commercial secondary batteries include nickel cadmium batteries, nickel hydrogen batteries, nickel zinc batteries, lithium secondary batteries, and the like, and among them, when compared to nickel-based secondary batteries, lithium-based secondary batteries have little memory effects and is free in charging and discharging as well as having a very low self-discharge rate and a high energy density, and thus are gaining attention in many fields.

Meanwhile, a secondary battery has an upper limit at which the secondary battery can be physically charged and a lower limit at which the secondary battery can be physically discharged. However, in an actual usage environment, charging and discharging is not performed up to the physical upper and lower limits. That is, a lower limit of a use area is set to be higher than a physical discharge limit point, and an upper limit of a use area is set to be lower than a physical charge limit point. Accordingly, when a state of a secondary battery reaches the set lower limit of the use area during discharging of the secondary battery, the secondary battery is said to be completely or fully discharged. Also, when a state of the secondary battery reaches the set upper limit of the use area during charging of the secondary battery, the secondary battery is said to be completely or fully charged. For example, a use area of a general lithium secondary battery is set based on voltage, and has a voltage interval from 3.7V to 4.2V. Thus, when a secondary battery is fully charged, an open-circuit voltage of the secondary battery is 4.2V.

When a use area is set as described in the foregoing, a charge amount of a secondary battery within the set use area is measured and calculated. That is, a charging/discharging current is counted based on a rated capacity of the secondary battery, and a state of charge (SOC) value is calculated based on a ratio of a current remaining capacity of a secondary battery to the rated capacity of the secondary battery, and 100% SOC represents full charge and 0% SOC represents full discharge.

However, a method of indicating a charge amount of a secondary battery using a SOC is difficult for a user to intuitively determine a remaining charge amount. Particularly, when a battery has a small amount of charge left, a user has difficulty in determining whether to stop using the battery immediately and charge the battery, or to use the battery a little longer and then charge the battery. Thus, methods which indicate a SOC of a battery in various ways to allow a user to check it have been developed, but there is an inconvenience in that the user has to check the SOC frequently. Accordingly, there is a need to conduct a study of an apparatus and method for warning a charge amount that may allow a user to understand a remaining charge amount of a battery more easily and provide a warning of a time for the user to charge the battery.

### SUMMARY OF THE DISCLOSURE

The present disclosure is designed to solve the above problem of the related art, and therefore the present disclosure is directed to providing an apparatus and method for warning a charge amount of a battery.

To achieve the object, an apparatus for warning a charge amount according to the present disclosure includes a storage unit to store an indication unit used to indicate a remaining charge amount of a battery and a warning value based on the indication unit, a measurement unit to measure an electrical characteristic value of the battery, a charge amount calculation unit to calculate a remaining charge amount from the measured electrical characteristic value of the battery, an indication unit conversion unit to convert the calculated remaining charge amount to an indication unit based on a power amount consumed in a load electrically connected to the battery by the indication unit, and a determination unit to output a warning signal when the converted remaining charge amount is less than or equal to the warning value.

According to an exemplary embodiment of the present disclosure, the indication unit may be a value input from a user by a selection.

According to an exemplary embodiment of the present disclosure, the indication unit may be a length or a time. Accordingly, the indication unit conversion unit may convert the remaining charge amount of the battery to an operable time or an operable length based on a power amount consumed in the load connected to the battery by a unit length or a unit time. In this case, the indication unit conversion unit may convert the remaining charge amount of the battery to the operable time or the operable length based on the following equation:

$$Y = \frac{Remaining Charge Amount ( mAh )}{Power Consumed in Load by Indication Unit ( mAh / x )}$$

where X denotes an indication unit (a time or a length) and Y denotes a converted remaining charge amount of a battery.

According to an exemplary embodiment of the present disclosure, the memory unit may store a preset power amount consumed in the load connected to the battery by the indication unit.

According to another exemplary embodiment of the present disclosure, the memory unit may store the calculated power amount consumed in the load connected to the battery by the indication unit based on the electrical characteristic value of the battery measured through the measurement unit.

According to an exemplary embodiment of the present disclosure, the warning value may be input from a user.

The apparatus for warning a charge amount according to the present disclosure may further include a global positioning system (GPS) module to output geographical location data of the battery using a signal received from a GPS satellite, and a warning value setting unit to select battery charging stations reachable with the remaining charge amount among battery charging stations located on a movement path of the battery predicted using at least two geographical location data, and to set a location of a last reachable battery charging station based on the indication unit among the selected battery charging stations as a warning value based on the indication unit. In this case, the apparatus for warning a charge amount may further include a charging station location information memory unit to store the location of the battery charging station.

The apparatus for warning a charge amount according to the present disclosure may further include a GPS module to output geographical location data of the battery using a signal received from a GPS satellite, and a warning value setting unit to select battery charging stations reachable with the remaining charge amount among battery charging stations located on a pre-input movement path of the battery, and to set a location of a last reachable battery charging station based on the indication unit among the selected battery charging stations as a warning value based on the indication unit. In this case, the apparatus for warning a charge amount may further include a charging station location information memory unit to store the location of the battery charging station.

The apparatus for warning a charge amount according to the present disclosure may further include a display unit to visually or auditorily display that the battery needs to be charged, in response to the warning signal being received from the determination unit.

The apparatus for warning a charge amount according to the present disclosure may be one component of a battery pack including a secondary battery assembly including at least two secondary batteries, and a battery management system (BMS) to control the charge and discharge of the secondary battery assembly.

The apparatus for warning a charge amount according to the present disclosure may be one component of a battery operating system including a battery pack, and a load that is supplied with power from the battery pack. The load may be an electric driving means or a power inverter circuit.

To achieve the object, a method for warning a charge amount according to the present disclosure includes (a) storing an indication unit used to indicate a state of charge (SOC) of a battery and a warning value based on the indication unit, (b) calculating and storing a remaining charge amount from an electrical characteristic value of the battery, (c) converting the calculated remaining charge amount of the battery to an indication unit based on a power amount consumed in a load connected to the battery by the indication unit, and (d) outputting a warning signal when the converted remaining charge amount is less than or equal to the warning value.

The method for warning a charge amount according to the present disclosure may further include, before the step (a), receiving an input of an indication unit selected by a user.

According to an exemplary embodiment of the present disclosure, the indication unit may be a length or a time. In this case, the step (c) may include converting the remaining charge amount of the battery to an operable time or an operable length based on a power amount consumed in the load connected to the battery by a unit length or a unit time. In this instance, the step (c) may include converting the remaining charge amount of the battery to the operable time or the operable length based on the following equation:

$$Y = \frac{Remaining Charge Amount ( mAh )}{Power Consumed in Load by Indication Unit ( mAh / x )}$$

where X denotes an indication unit (a time or a length) and Y denotes a converted remaining charge amount of a battery.

According to an exemplary embodiment of the present disclosure, the step (a) may include additionally storing a preset power amount consumed in the load connected to the battery by the indication unit.

The method for warning a charge amount according to the present disclosure may further include storing the calculated power amount consumed in the load connected to the battery by the indication unit based on the electrical characteristic value of the battery measured in the step (b).

The method for warning a charge amount according to the present disclosure may further include, before the step (a), receiving an input of a warning value selected by a user.

The method for warning a charge amount according to the present disclosure may further include, before the step (a), outputting geographical location data of the battery using a signal received from a GPS satellite, and selecting battery charging stations reachable with the remaining charge amount among battery charging stations located on a movement path of the battery predicted using at least two geographical location data, and setting a location of a last reachable battery charging station based on the indication unit among the selected battery charging stations as a warning value based on the indication unit.

The method for warning a charge amount according to the present disclosure may further include, before the step (a), outputting geographical location data of the battery using a signal received from a GPS satellite, and selecting battery charging stations reachable with the remaining charge amount among battery charging stations located on a pre-input movement path of the battery, and setting a location of a last reachable battery charging station based on the indication unit among the selected battery charging stations as a warning value based on the indication unit.

According to an aspect of the present disclosure, a warning may be provided to charge a battery before the battery is fully discharged. In this instance, the warning may be set to be provided by a unit of a desired form at a desired point in time by a user, so when the user uses a device including the battery, predictability in operation or management may be further improved.

According to another aspect of the present disclosure, being associated with a location of a charging station that supplies a charging power to a battery may allow a user to determine a time to charge.

### BRIEF DESCRIPTION OF THE DRAWINGS

The accompanying drawings illustrate a preferred embodiment of the present disclosure and together with the foregoing disclosure, serve to provide further understanding of the technical spirit of the present disclosure, and thus, the present disclosure is not construed as being limited to the drawings.

FIG. 1 is a block diagram schematically illustrating a construction of an apparatus for warning a charge amount according to an exemplary embodiment.

FIG. 2 is a block diagram schematically illustrating a construction of an apparatus for warning a charge amount according to another exemplary embodiment.

FIG. 3 is a conceptual diagram illustrating an algorithm for setting a warning value.

FIG. 4 is a flowchart chronologically illustrating a method for warning a charge amount according to an exemplary embodiment.

FIG. 5 is a flowchart chronologically illustrating a method for warning a charge amount according to another exemplary embodiment.

### DESCRIPTION OF THE PREFERRED EMBODIMENT

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just a preferable example for the purpose of illustrations only, not intended to limit the scope of the disclosure, so it should be understood that other equivalents and modifications could be made thereto without departing from the spirit and scope of the disclosure.

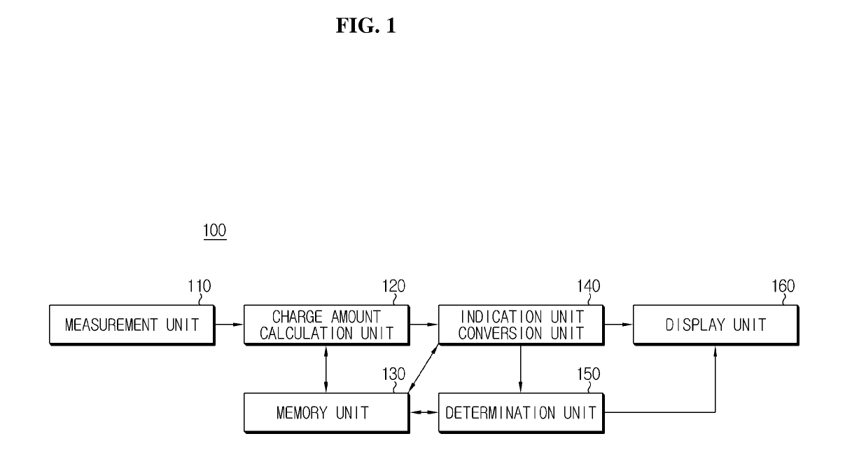

FIG. 1 is a block diagram schematically illustrating a construction of an apparatus 100 for warning a charge amount according to an exemplary embodiment.

Referring to FIG. 1, the apparatus 100 for warning a charge amount according to the present disclosure includes a measurement unit 110, a charge amount calculation unit 120, a memory unit 130, an indication unit conversion unit 140, and a determination unit 150.

The measurement unit 110 measures an electrical characteristic value of a battery. Also, the measurement unit 110 outputs the measured electrical characteristic value of the battery to the charge amount calculation unit 120.

The battery includes at least one secondary battery cell, and the secondary battery cell is not limited to a specific type. Each secondary battery cell may include a lithium ion battery, a lithium polymer battery, a nickel cadmium battery, a nickel hydrogen battery, and a nickel zinc battery that is rechargeable and requires consideration of a charging or discharging voltage. It is general to construct a high capacity high output battery pack by connecting a plurality of secondary battery cells in parallel, in series, or in parallel/series. However, the present disclosure is not limited by a type, an output voltage, and a charge capacity of a secondary battery cell, a number of secondary battery cells constituting a battery pack, a connection method, and the like.

The electrical characteristic value represents a voltage or a current of the battery. The voltage of the battery represents an output voltage, and the voltage may be a dynamic voltage measured during charging or discharging of the battery or an open-circuit voltage (OCV) of the battery. Also, it is obvious that the current is measured during charging or discharging of the battery. Meanwhile, a temperature value of the battery may be included in the electrical characteristic value. The battery generally generates heat during charging or discharging, and in this instance, the generated heat may affect the battery performance.

The measurement unit 110 includes a sensing element to measure the electrical characteristic value of the battery. The sensing element may be a voltage measurement element to measure the voltage of the battery and a current measurement element to measure the current of the battery. Also, the sensing element may include a temperature measurement element to measure the temperature of the battery. Because a principle, a construction, a type, and a connection method of the voltage measurement element, the current measurement element, or the temperature measurement element are well-known technologies to a person having ordinary skill in the technical field to which the present disclosure belongs (hereinafter referred to as a ‘skilled person’), its detailed description is omitted herein.

The charge amount calculation unit 120 calculates a remaining charge amount of the battery using the electrical characteristic value of the battery received from the measurement unit 110. Also, the calculated remaining charge amount of the battery may be stored in the memory unit 130.

There are various known techniques for calculating a remaining charge amount of a battery in the technical field to which the present disclosure belongs. For example, because a voltage value of a secondary battery is in proportion to a charge amount, there is a method that calculates a remaining charge amount of a battery using a measured voltage value of the battery. A use area of a general lithium secondary battery is set based on voltage, and has a voltage interval from 3.7V to 4.2V. Accordingly, when an open-circuit voltage of a secondary battery is 4.2V, it implies that the battery is fully charged, and when an open-circuit voltage of a secondary battery is 3.7V, it implies that the battery is fully discharged. As another example, there is a method that calculates a remaining charge amount of a battery by counting a current value measured when charging or discharging the battery (so-called ‘ampere counting’) and calculating a state of charge (SOC). This method counts a charging/discharging current based on a rated capacity of a secondary battery, and calculates a SOC value based on a ratio of a current remaining capacity to the rated capacity. 100% SOC represents full charge, and 0% SOC represents full discharge. However, it should be understood that the scope of the present disclosure is not limited by the exemplary methods, and all methods of calculating a remaining charge amount known to a skilled person at the time of filing the application may be applicable.

The memory unit 130 stores an indication unit used to indicate the remaining charge amount of the battery. The indication unit represents a time or a length during which a load connected to the battery can operate when the remaining charge amount of the battery is supplied to the load. Accordingly, the indication unit may have a unit of length or time. The indication unit may be a value input from a user by selection, and may be a value input when manufacturing the apparatus 100 for warning a charge amount according to the present disclosure.

The memory unit 130 according to the present disclosure corresponds to a high-capacity storage medium such as a semiconductor device or a hard disk that is known as being capable of recording and erasing data, for example, random access memory (RAM), read-only memory (ROM), electrical erasable programmable read-only memory (EEPROM), and the like, and encompasses any device capable of storing information regardless of a device type and is not limited to a specific memory device.

The indication unit conversion unit 140 converts the remaining charge amount calculated by the charge amount calculation unit 120 to an indication unit stored in the memory unit 130 based on a power amount consumed in the load electrically connected to the battery by the indication unit.

Generally, a charge amount of a battery is displayed in ‘mAh’. However, ‘mAh’ is difficult for even an expert as well as a general user to easily determine a current remaining charge amount of a battery and predict how longer a load connected to the battery can operate. Accordingly, the indication unit conversion unit 140 converts to an indication unit stored in the memory unit 130 to allow a user to intuitively determine the remaining charge amount of the battery. In this instance, when the indication unit is a length or a time, the indication unit conversion unit 140 converts to a time or a length during which the load connected to the battery can operate with the remaining charge amount of the battery.

The indication unit conversion unit 140 converts the calculated remaining charge amount to an indication unit based on a power amount consumed in the load electrically connected to the battery by the indication unit. That is, the indication unit conversion unit 140 converts the remaining charge amount of the battery to an operable time or an operable length based on a power amount consumed in the load connected to the battery by a unit length or unit time. In this instance, the indication unit conversion unit 140 may perform a conversion based on the following Equation 1.

$$Y = \frac{Remaining Charge Amount ( mAh )}{\begin{matrix}Power Consumed in Load \\ by Indication Unit ( mAh / x )\end{matrix}} \qquad [ Equation 1 ]$$

(X: an indication unit (a time or length), Y: a converted remaining charge amount of a battery)

As seen through the above Equation 1, in the conversion of the remaining charge amount of the battery, an important parameter is a power amount consumed in the load electrically connected to the battery by the indication unit. That is, even though the same power supply is provided, a time or a length during which the load can operate may vary depending on a power amount consumed in the load.

According to an exemplary embodiment, a power amount consumed in the load connected to the battery by the indication unit is preset and stored in the memory unit 130. If a power amount consumed in the load connected to the battery has a characteristic of not being influenced by an environment such as a time and a place, it is possible to measure a power amount consumed in the load and pre-store it in the memory unit 130.

According to another exemplary embodiment, a calculated power amount consumed in the load connected to the battery by the indication unit based on the electrical characteristic value of the battery measured through the measurement unit 110 is stored in the memory unit 130. If a power amount consumed in the load connected to the battery has a characteristic of varying depending on an environment such as a time and a place, it is possible to calculate a power amount consumed in the load connected to the battery each time and store it in the memory unit 130. In this instance, a time to calculate a power amount consumed in the load connected to the battery, a number of times of calculations, and an interval therebetween may be variously set.

The determination unit 150 compares the converted remaining charge amount by the indication unit conversion unit 140 to a warning value stored in the memory unit 130. The warning value is a reference point for providing a warning that the battery needs to be charged. Also, when the converted remaining charge amount is less than or equal to the warning value, the determination unit 150 outputs a warning signal.

The apparatus 100 for warning a charge amount according to the present disclosure may further include a display unit 160 to visually or auditorily display that the battery needs to be charged, in response to the warning signal being received from the determination unit 150. The display unit 160 may be a user interface (UI) or an icon displayed on a display unit, a lamp, a light-emitting diode (LED), a buzzer, a speaker, a liquid crystal display (LCD), an LED display, and the like.

For example, there is a dashboard in a driver's seat of an electric vehicle to display a state of the vehicle, and the dashboard may comprise a warning lamp of which light is off in a normal mode and flashes in response to the warning signal. As another example, a warning may be provided to a user in a form of a UI on a screen of a LCD display of a portable electronic device along with a sound.

According to an exemplary embodiment, the warning value may be input from a user. That is, the user may input the warning value to enable the apparatus 100 for warning a charge amount according to the present disclosure to notify a time to charge, while variously considering a use environment and a purpose such as a purpose of use, a charging period, a use time, and a desired output of the load connected to the battery.

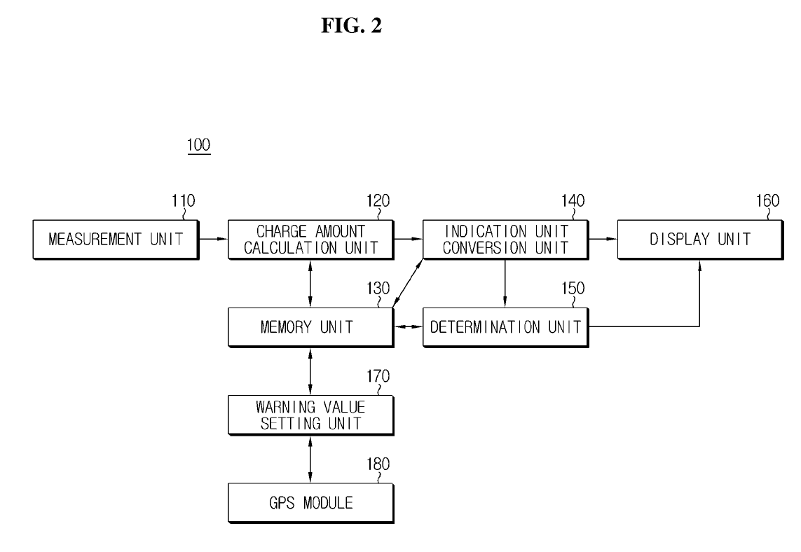

FIG. 2 is a block diagram schematically illustrating a construction of an apparatus 100 for warning a charge amount according to another exemplary embodiment.

Referring to FIG. 2, the apparatus 100 for warning a charge amount according to the present disclosure may further include a global positioning system (GPS) module 180 and a warning value setting unit 170, compared to the embodiment shown in FIG. 1.

The GPS module 180 outputs geographical location data of the battery using a signal received from a GPS satellite.

The GPS module 180 outputs data associated with a current geographical location of the battery using a signal received from a GPS satellite. The GPS-assisted location measurement is a method that calculates a current geographical location by calculating and measuring an orbital distance of a GPS satellite and a delay time of a wave transmitted from the satellite. The GPS module 180 may output the geographical location of the battery as data represented by latitude and longitude. Also, the GPS module 180 may output the data associated with the geographical location of the battery in real time, periodically, or at a required point in time. Because a GPS technology is a known technology, its detailed description is omitted herein.

The warning value setting unit 170 selects battery charging stations reachable with the remaining charge amount among battery charging stations located on a movement path of the battery, and sets, as a warning value based on the indication unit, a location of a last reachable battery charging station based on the indication unit among the selected battery charging stations.

Hereinafter, for convenience of description, a description will be provided under the assumption that the apparatus 100 for warning a charge amount according to the present disclosure is an apparatus mounted in an electric vehicle in which a motor operates with power supplied from a battery pack including secondary batteries. However, the present disclosure is not limited by an exemplary target for use of the present disclosure or an exemplary purpose of use of the present disclosure.

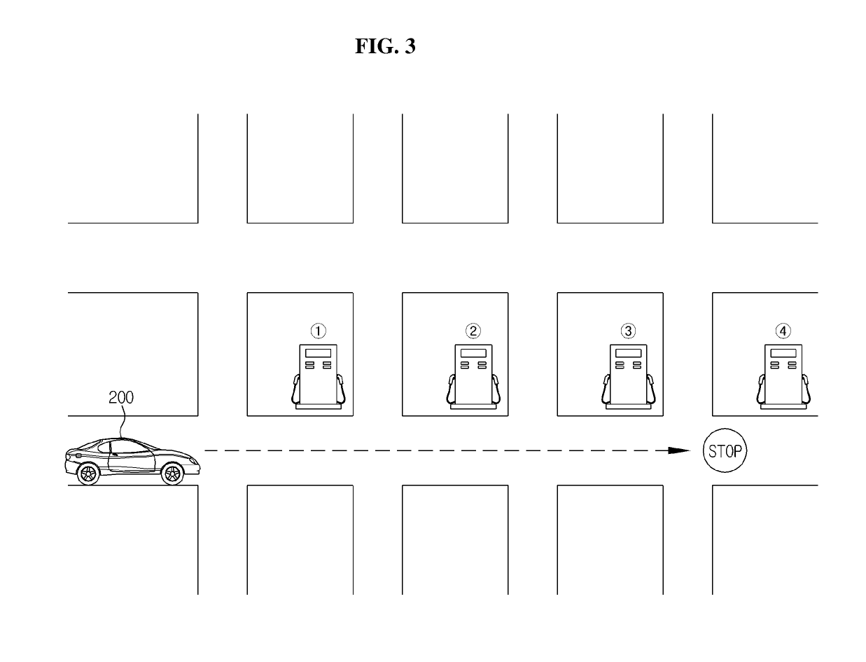

FIG. 3 is a conceptual diagram illustrating an algorithm for setting the warning value.

Referring to FIG. 3, as illustrated, an electric vehicle 200 with a battery mounted therein moves from left to right in the drawing. Also, a total of four battery charging stations \textcircled{1}˜\textcircled{4} are located on a movement path of the electric vehicle. Also, a moveable distance of the electric vehicle 200 with the remaining charge amount is indicated with a dotted line by the indication unit conversion unit 140. That is, the remaining charge amount of the battery is sufficient for the electric vehicle 200 to pass by the third battery charging station \textcircled{3}, but insufficient for the electric vehicle 200 to reach the fourth battery charging station \textcircled{4}.

In this instance, the warning value setting unit 170 selects battery charging stations reachable with the remaining charge amount among the battery charging stations located on the movement path of the battery. In the embodiment shown in FIG. 3, such battery charging station is \textcircled{1} to \textcircled{3} battery charging stations. Also, among the \textcircled{1} to \textcircled{3} battery charging stations, the warning value setting unit 170 sets a location of the last reachable battery charging station \textcircled{3} as a warning value.

The warning value may be set to provide a warning to a user when the user reaches a place matching with the location of the battery charging station, and for convenience of the user, when the user reaches a location within a preset radius from the battery charging station or at a preset time before the user is expected to reach the battery charging station. The preset radius or preset time may be variously set and stored in the memory unit 130.

The battery charging station represents a place in which all types of chargers capable of supplying a charging power of the battery mounted in the electric vehicle are included, and includes, but is not limited to, a paid or free battery charging station, a commercial or non-commercial battery charging station, and a battery charging station for a domestic or business use, according to an operation type.

The apparatus 100 for warning a charge amount according to the present disclosure may further include a charging station location information memory unit (not shown) to store the location of the battery charging station. The charging station location information memory unit may be included in the memory unit 130, and may be disposed outside of the memory unit 130. Also, the charging station location information memory unit may be an internal or external memory device included in a separate device from the apparatus 100 for warning a charge amount according to the present disclosure, for example, an automobile navigation device or the like.

According to an exemplary embodiment of the present disclosure, the movement path of the battery may be predicted using at least two geographical location data. The GPS module installed in a moving device calculates different geographical locations by GPS satellite signals received at different points in time. Accordingly, the warning value setting unit 170 may determine a movement from a geographical location calculated at an earlier time to a geographical location calculated at a later time.

According to another exemplary embodiment of the present disclosure, the movement path of the battery may be pre-input. For input of the movement path, the warning value setting unit 170 may have a terminal for data input or output. Also, the movement path may be information input through a separate device from the apparatus 100 for warning a charge amount according to the present disclosure, for example, an automobile navigation device or the like.

The apparatus 100 for warning a charge amount according to the present disclosure may be one component of a battery pack including a secondary battery assembly made up of a plurality of secondary batteries connected in series or parallel and a battery management system (BMS) to control the charge and discharge of the secondary battery assembly. In this case, the apparatus 100 for warning a charge amount may be integrated with the BMS or may be implemented as a separate circuit device.

Also, the apparatus 100 for warning a charge amount according to the present disclosure may be one component of a battery operating system including the battery pack and the load which is supplied with power from the battery pack.

The battery operating system may be, for example, an electric vehicle (EV), a hybrid electric vehicle (HEV), an electric bike, a power tool, an energy storage system including the plurality of battery packs, an uninterruptible power system (UPS), a portable computer, a mobile phone, a portable audio device, a portable video device, and the like, and the load may be, for example, a motor which provides a rotary force by power supplied from the battery pack or a power inverter circuit which changes power supplied from the battery pack to power required for various circuit components.

Hereinafter, a method for warning a charge amount corresponding to an operation mechanism of the foregoing-described apparatus is disclosed. However, when a component included in the apparatus 100 for warning a charge amount as described previously is referred to again, an overlapping description of a function of the corresponding component is omitted herein.

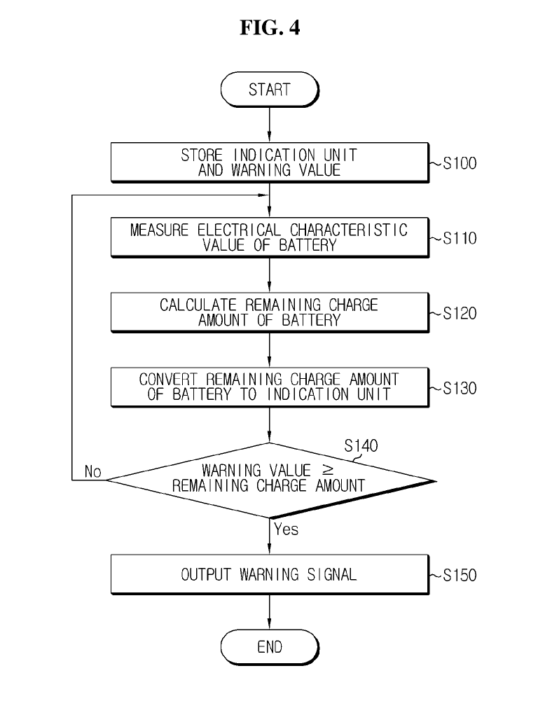

FIG. 4 is a flowchart chronologically illustrating a method for warning a charge amount according to an exemplary embodiment of the present disclosure.

Referring to FIG. 4, first, in S100, an indication unit used to indicate a SOC of a battery and a warning value based on the indication unit is stored in the memory unit 130. As described in the foregoing, the indication unit may be a unit of length or time.

Meanwhile, in S100, the warning value may be stored in the memory unit 130 through a step of receiving an input of the warning value selected by a user.

According to an exemplary embodiment of the present disclosure, S100 may include additionally storing a preset power amount consumed in a load connected to the battery by the indication unit.

Subsequently, in S110, the measurement unit 110 measures an electrical characteristic value of the battery. Also, the measurement unit 110 outputs the measured electrical characteristic value of the battery to the charge amount calculation unit 120.

In S120, the charge amount calculation unit 120 calculates and stores a remaining charge amount of the battery using the electrical characteristic value of the battery measured in S110. In this step, a method of calculating the remaining charge amount of the battery may be various, as described in the foregoing.

Meanwhile, after S110, a step of calculating a power amount consumed in the load connected to the battery by the indication unit using the electrical characteristic value of the battery measured in S110 and storing it in the memory unit 130 may be added.

In S130, the indication unit conversion unit 140 converts the calculated remaining charge amount of the battery to an indication unit based on the power amount consumed in the load connected to the battery by the indication unit.

According to an exemplary embodiment of the present disclosure, when the indication unit is a length or a time, S130 may include converting the remaining charge amount of the battery to an operable time or an operable length based on a power amount consumed in the load connected to the battery by a unit length or a unit time.

In this instance, in S130, the remaining charge amount of the battery may be converted to the operable time or operable length based on the above Equation 1.

Subsequently, in S140, the determination unit 150 determines whether the converted remaining charge amount is less than or equal to the warning value. When the converted remaining charge amount is higher than the warning value (NO in S140), the process reverts to S110. Also, S110 through S140 are performed iteratively. A cycle of iterative execution may be variously set based on a data processing rate of the apparatus 100 for warning a charge amount according to the present disclosure, and may be variously set based on an environment in which the apparatus 100 for warning a charge amount according to the present disclosure is used.

Meanwhile, when the converted remaining charge amount is less than or equal to the warning value (YES in S140), the process goes to S150. Also, in S150, the determination unit 150 outputs a warning signal.

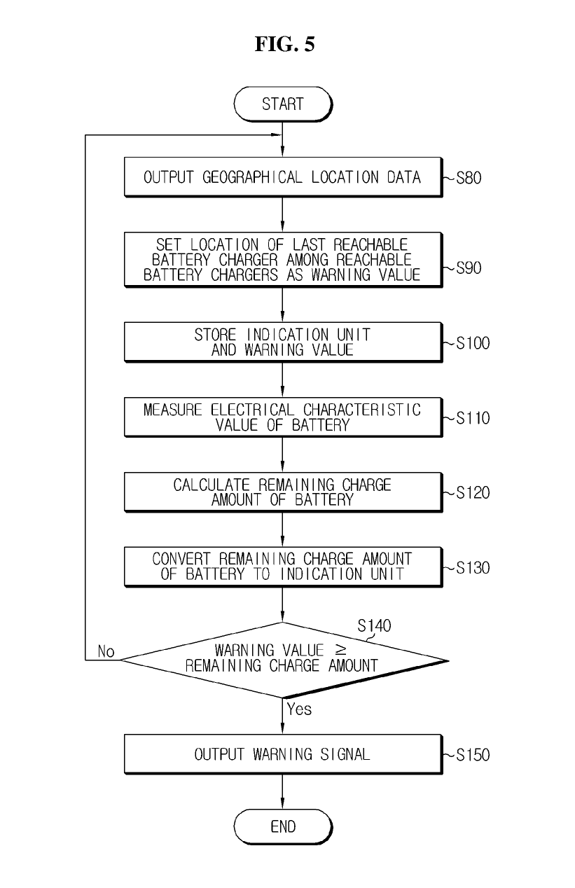

FIG. 5 is a flowchart chronologically illustrating a method for warning a charge amount according to another exemplary embodiment of the present disclosure.

Referring to FIG. 5, it can be seen that S100 through S150 are the same as in the previous embodiment shown in FIG. 4. Accordingly, a description will be provided based on S80 and S90 added before S100.

The embodiment shown in FIG. 5 corresponds to an operation algorithm of the apparatus 100 for warning a charge amount shown in FIG. 2. Referring to FIG. 5 together with FIG. 2, in S80, the GPS module 180 outputs geographical location data of the battery using a signal received from a GPS satellite.

Subsequently, in S90, the warning value setting unit 170 selects battery charging stations reachable with the remaining charge amount among battery charging stations located on a movement path of the battery, and sets a location of a last reachable battery charging station based on the indication unit among the selected battery charging stations as a warning value based on the indication unit. Because an algorithm for setting the warning value is described above with reference to FIG. 3, an overlapping description is omitted herein.

According to an exemplary embodiment of the present disclosure, the movement path of the battery may be predicted using at least two geographical location data.

According to another exemplary embodiment of the present disclosure, the movement path of the battery may be pre-input.

According to the present disclosure, a warning may be provided to charge the battery before the battery is fully discharged. In this instance, the warning may be set to be provided by a unit of a desired form at a desired point in time by a user, so when the user uses a device including the battery, predictability in operation and management may be further improved. Also, being associated with a location of a charging station that supplies a charging power to the battery may allow the user to determine a time to charge.

Meanwhile, in the description of the present disclosure, it should be understood that each component of the apparatus 100 for warning a charge amount according to the present disclosure shown in FIGS. 1 and 2 is distinguished logically rather than physically.

That is, each element or component corresponds to a logic element or component to realize the technical idea of the present disclosure, and accordingly, it should be understood that even though each element or component is integrated or separated, it falls within the scope of the present disclosure if a function performed by a logic element or component of the present disclosure can be implemented, and it falls within the scope of the present disclosure regardless of whether names are identical or not if it is an element or component performing an identical or similar function.

According to an aspect of the present disclosure, to execute various control logics described in the foregoing, the charge amount calculation unit 120, the indication unit conversion unit 140, the determination unit 150, and the warning value setting unit 170 may include a processor, an application-specific integrated circuit (ASIC), a chipset, a logic circuit, a register, a communication modem, a data processing device, and the like, known in the technical field to which the present disclosure belongs. Also, when the foregoing-described control logics are implemented as software, the charge amount calculation unit 120, the indication unit conversion unit 140, the determination unit 150, and the warning value setting unit 170 may be implemented as an assembly of program modules. In this instance, the program module may be stored in a memory and executed by a processor. Here, the memory may be inside or outside the processor, and connected to the processor by various well-known means. Also, the memory may be inside or outside the memory unit 130. The memory collectively refers to a device used to store information regardless of a device type, and is not limited to a specific memory device.

The present disclosure has been described in detail. However, it should be understood that the detailed description and specific examples, while indicating preferred embodiments of the disclosure, are given by way of illustration only, since various changes and modifications within the spirit and scope of the disclosure will become apparent to those skilled in the art from this detailed description.

What is claimed is:

1. An apparatus for warning a charge amount, comprising:
a storage unit to store an indication unit used to indicate a remaining charge amount of a battery and a warning value based on the indication unit;
a measurement unit to measure an electrical characteristic value of the battery;
a charge amount calculation unit to calculate a remaining charge amount from the measured electrical characteristic value of the battery;
an indication unit conversion unit to convert the calculated remaining charge amount to an indication unit based on a power amount consumed in a load electrically connected to the battery by the indication unit; and
a determination unit to output a warning signal when the converted remaining charge amount is less than or equal to the warning value.

2. The apparatus for warning a charge amount according to claim 1, wherein the indication unit is a value input from a user by a selection.

3. The apparatus for warning a charge amount according to claim 1, wherein the indication unit is a length or a time.

4. The apparatus for warning a charge amount according to claim 3, wherein the indication unit conversion unit converts the remaining charge amount of the battery to an operable time or an operable length based on a power amount consumed in the load connected to the battery by a unit length or a unit time.

5. The apparatus for warning a charge amount according to claim 4, wherein the indication unit conversion unit converts the remaining charge amount of the battery to the operable time or the operable length based on the following equation:
$$Y = \frac{Remaining Charge Amount ( mAh )}{Power Consumed in Load by Indication Unit ( mAh / x )}$$
where X denotes an indication unit (a time or a length) and Y denotes a converted remaining charge amount of a battery.

6. The apparatus for warning a charge amount according to claim 1, wherein the memory unit stores a preset power amount consumed in the load connected to the battery by the indication unit.

7. The apparatus for warning a charge amount according to claim 1, wherein the memory unit stores the calculated power amount consumed in the load connected to the battery by the indication unit based on the electrical characteristic value of the battery measured through the measurement unit.

8. The apparatus for warning a charge amount according to claim 1, wherein the warning value is input from a user.

9. The apparatus for warning a charge amount according to claim 1, further comprising:
a global positioning system (GPS) module to output geographical location data of the battery using a signal received from a GPS satellite; and
a warning value setting unit to select battery charging stations reachable with the remaining charge amount among battery charging stations located on a movement path of the battery predicted using at least two geographical location data, and to set a location of a last reachable battery charging station based on the indication unit among the selected battery charging stations as a warning value based on the indication unit.

10. The apparatus for warning a charge amount according to claim 9, further comprising:
a charging station location information memory unit to store the location of the battery charging station.

11. The apparatus for warning a charge amount according to claim 1, further comprising:
a GPS module to output geographical location data of the battery using a signal received from a GPS satellite; and
a warning value setting unit to select battery charging stations reachable with the remaining charge amount among battery charging stations located on a pre-input movement path of the battery, and to set a location of a last reachable battery charging station based on the indication unit among the selected battery charging stations as a warning value based on the indication unit.

12. The apparatus for warning a charge amount according to claim 11, further comprising:
a charging station location information memory unit to store the location of the battery charging station.

13. The apparatus for warning a charge amount according to claim 1, further comprising:
a display unit to visually or auditorily display that the battery needs to be charged, in response to the warning signal being received from the determination unit.

14. A battery pack comprising:
an apparatus for warning a charge amount defined in claims 1;
a secondary battery assembly including at least two secondary batteries; and
a battery management system (BMS) to control the charge and discharge of the secondary battery assembly.

15. A battery operating system comprising:
a battery pack defined in claims 14; and
a load that is supplied with power from the battery pack.

16. The battery operating system according to claim 15, wherein the load is an electric driving means or a power inverter circuit.

17. A method for warning a charge amount, comprising:
(a) storing an indication unit used to indicate a state of charge (SOC) of a battery and a warning value based on the indication unit;
(b) calculating and storing a remaining charge amount from an electrical characteristic value of the battery;
(c) converting the calculated remaining charge amount of the battery to an indication unit based on a power amount consumed in a load connected to the battery by the indication unit; and
(d) outputting a warning signal when the converted remaining charge amount is less than or equal to the warning value.

18. The method for warning a charge amount according to claim 17, further comprising:
before the step (a), receiving an input of an indication unit selected by a user.

19. The method for warning a charge amount according to claim 17, wherein the indication unit is a length or a time.

20. The method for warning a charge amount according to claim 19, wherein the step (c) comprises converting the remaining charge amount of the battery to an operable time or an operable length based on a power amount consumed in the load connected to the battery by a unit length or a unit time.

21. The method for warning a charge amount according to claim 20, wherein the step (c) comprises converting the remaining charge amount of the battery to the operable time or the operable length based on the following equation:
$$Y = \frac{Remaining Charge Amount ( mAh )}{Power Consumed in Load by Indication Unit ( mAh / x )}$$
where X denotes an indication unit (a time or a length) and Y denotes a converted remaining charge amount of a battery.

22. The method for warning a charge amount according to claim 17, wherein the step (a) comprises additionally storing a preset power amount consumed in the load connected to the battery by the indication unit.

23. The method for warning a charge amount according to claim 17, further comprising:
storing the calculated power amount consumed in the load connected to the battery by the indication unit based on the electrical characteristic value of the battery measured in the step (b).

24. The method for warning a charge amount according to claim 17, further comprising:
before the step (a), receiving an input of a warning value selected by a user.

25. The method for warning a charge amount according to claim 17, further comprising:
before the step (a),
outputting geographical location data of the battery using a signal received from a global positioning system (GPS) satellite; and
selecting battery charging stations reachable with the remaining charge amount among battery charging stations located on a movement path of the battery predicted using at least two geographical location data, and setting a location of a last reachable battery charging station based on the indication unit among the selected battery charging stations as a warning value based on the indication unit.

26. The method for warning a charge amount according to claim 17, further comprising:
before the step (a),
outputting geographical location data of the battery using a signal received from a GPS satellite; and
selecting battery charging stations reachable with the remaining charge amount among battery charging stations located on a pre-input movement path of the battery, and setting a location of a last reachable battery charging station based on the indication unit among the selected battery charging stations as a warning value based on the indication unit.
